(19) United States
(12) Patent Application Publication
(10) Pub. No.: US 2008/0026272 A1
(43) Pub. Date: Jan. 31, 2008

(54) Fuel supply system for fuel cell and fuel cell system using the same

(76) Inventors: Ming Zi Hong, Yongin-si (KR); Hyun Kim, Yongin-si (KR)

Correspondence Address: Robert E. Bushnell, Suite 300, 1522 K Street, N.W., Washington, DC, 20005-1202, US

(21) Appl. No.: 11/822,554

(22) Filed: Jul. 6, 2007

(30) Foreign Application Priority Data
Jul. 28, 2006 (KR) 10-2006-0071737

(51) Int. Cl. H01M 8/04

(52) U.S. Cl. 429/23; 429/61

(57) ABSTRACT

A fuel supply system and a fuel cell system using the same, in which the concentration of fuel to be supplied to a stack is constantly and accurately controlled only on the basis of measured current in a direct methanol fuel cell system. The fuel supply system includes an electric generating unit adapted to generate electric energy based upon an electrochemical reaction between a fuel and an oxidant, a fuel storage unit adapted to store fuel and to supply fuel to the electric generating unit, a recycling unit adapted to store unreacted fuel and water emitted from the electric generating unit, a first fuel transferring unit adapted to transfer the fuel stored in the fuel storage unit to the recycling unit, a second fuel transferring unit adapted to transfer the fuel within the recycling unit to the electric generating unit and a control unit adapted to calculate consumption speed of the fuel consumed in the electric generating unit based on a current generated by the electric generating unit, and the control unit being further adapted to control a volume flow rate of the fuel transferred from the fuel storage unit to the recycling unit in correspondence to the calculated consumption speed

### CLAIM OF PRIORITY

This application makes reference to, incorporates the same herein, and claims all benefits accruing under 35 U.S.C.§119 from an application for FUEL SUPPLYSYSTEM FOR FUEL CELL AND FUEL CELL SYSTEM USING THE SAME earlier filed in the Korean Intellectual Property Office on 28 Jul. 2006 and there duly assigned Serial No. 2006-0071737.

### BACKGROUND OF THE INVENTION

1. Field of the Invention

The present invention relates to a fuel cell system, and more particularly, to a fuel supply system for a fuel cell and a direct methanol fuel cell system using the same, in which the concentration of liquid hydrogen-containing fuel supplied to an electric generator of the fuel cell system is constantly and accurately controlled.

2. Description of the Related Art

In general, a fuel cell is a power generating system that directly transforms fuel energy into electric energy, and has advantages of low environmental pollution and high efficiency. Particularly, the fuel cell uses an energy source such as natural gas, methanol, etc., which can be easily stored and carried, in generating electric energy, so that the fuel cell has attracted attention as a next generation energy source. Such a fuel cell is classified into a direct methanol fuel cell (DMFC), a phosphoric acid fuel cell (PAFC), a molten carbon fuel cell (MCFC), a solid oxide fuel cell (SOFC), a polymer electrolyte membrane fuel cell (PEMFC), an alkaline fuel cell (AFC), etc. These fuel cells operate on basically the same principle, but they are different in the kind of fuel used, operating temperature, catalyst used, electrolyte used, and so on.

The DMFC employs a polymer membrane as the electrolyte for conducting a hydrogen ion (proton), and directly supplies methanol aqueous solution as the fuel to an anode. The DMFC is not in need of a fuel reformer, and has a stack structure in which a plurality of unit cells are structurally or electrically connected. Further, the DMFC is driven at a temperature of less than 100° C. Thus, the DMFC is suitable for a portable or small fuel cell structure.

Generally, the output performance of the DMFC is varied according to states of the fuel cell system, such as the temperature of the stack, the supplying amount of fuel, the concentration of fuel, etc. In particular, the concentration of fuel is an important variable closely related to a voltage-current graph of the fuel cell. That is, there is an optimum concentration of fuel allowing the DMFC to have the maximum efficiency. Accordingly, a fuel concentration sensor has been used in DMFC systems to find the optimum concentration of fuel and thus enhance the stability and the efficiency of operation. Therefore, the stability and the efficiency of the fuel cell system are improved as the fuel is supplied in correspondence to the optimum concentration of fuel.

However, most of the fuel concentration sensors deteriorate in sensitivity as they are used. Accordingly, a problem arises regarding the reliability of the concentration sensor after a predetermined period of time. Therefore, it is difficult to drive the conventional DMFC system for a long time while using the concentration sensor to maintain the optimum operating efficiency.

In the meantime, for example, there has been disclosed a conventional DMFC system in Korean Patent First Publication No. 2004-21651 (published on Mar. 10, 2004). This conventional DMFC system does not use a concentration sensor and controls the amount of methanol or water supplied to a fuel solution storage on the basis of output voltage levels of the fuel cell stack. In this case, it is determined that the concentration of methanol has decreased when the voltage level detected by the fuel cell stack gets lower. On the other hand, it is determined that the concentration of methanol has increased when the voltage level detected by the fuel cell stack gets higher. Such a method of supplying the fuel can make the concentration of methanol reach the optimum concentration by increasing or decreasing the amount of methanol or water accordingly as the output voltage level of the fuel cell stack rises or lowers and is not at the accurate optimum concentration of the methanol solution required by the fuel cell stack. Therefore, there is a limit to enhance the stability and the efficiency of the fuel cell system. Further, because the amount change of materials currently produced in the fuel cell is not precisely controlled, it is impossible to promptly make a response to the change in the fuel cell stack. Therefore, the control of the fuel cell stack drops behind, thereby lowering the control accuracy. What is therefore needed is an improved technique for controlling the concentration of methanol or water supplied to the fuel cell system.

### SUMMARY OF THE INVENTION

Accordingly, it is an aim of the present invention to provide a fuel supply system which can accurately control the concentration of fuel according to the intensity of current measured by a direct methanol fuel cell system, without a concentration sensor for sensing the concentration of fuel.

Another aim of the present invention is to provide a fuel cell system using the foregoing fuel supply system, which can be easily established and in which the stability and the efficiency of the fuel cell system are enhanced.

According to one aspect of the present invention, there is provided a fuel supply system that includes an electric generating unit adapted to generate electric energy based upon an electrochemical reaction between a fuel and an oxidant, a fuel storage unit adapted to store fuel and to supply fuel to the electric generating unit, a recycling unit adapted to store unreacted fuel and water emitted from the electric generating unit, a first fuel transferring unit adapted to transfer the fuel stored in the fuel storage unit to the recycling unit, a second fuel transferring unit adapted to transfer the fuel within the recycling unit to the electric generating unit; and a control unit adapted to calculate consumption speed of the fuel consumed in the electric generating unit based on a current generated by the electric generating unit, and the control unit being further adapted to control a volume flow rate of the fuel transferred from the fuel storage unit to the recycling unit in correspondence to the calculated consumption speed.

A relationship between the volume flow rate of the fuel transferred from the fuel storage unit to the recycling unit in correspondence to the consumption speed of the fuel and the intensity of the current can be expressed as a linear function within at least a range. The volume flow rate of the fuel transferred from the fuel storage unit to the recycling unit can have a minimum amount determined by characteristics of the electric generating unit. The fuel supply system can further include a current detecting unit adapted to detect the intensity of the current generated in the electric generating unit.

According to another aspect of the present invention, there is provided a fuel supply system that includes an electric generating unit adapted to generate electric energy based upon an electrochemical reaction between a fuel and an oxidant, a fuel storage unit adapted to store the fuel, a fluid removing unit adapted to discharge undesired fluids among fluids emitted from the electric generating unit, a mixing unit adapted to store unreacted fuel and water among the fluids coming out from the electric generating unit, a first fuel transferring unit adapted to transfer the fuel stored in the fuel storage unit to the mixing unit and a control unit adapted to calculate a consumption speed of the fuel consumed in the electric generating unit based upon a current generated by the electric generating unit, and further adapted to control volume flow rate of the fuel transferred from the fuel storage unit to the mixing unit in correspondence to the calculated consumption speed.

A relationship between the volume flow rate of the fuel transferred from the fuel storage unit to the mixing unit in correspondence to the consumption speed of the fuel and the intensity of the current can be expressed as a linear function within at least a range, and the volume flow rate of the fuel transferred from the fuel storage unit to the mixing unit has a minimum amount determined by characteristics of the electric generating unit. The fuel transferring unit can also include at least one of a pump of which operating speed is controlled by the control unit and a valve of which a channel opening is adjusted by the control unit. The electric generating unit can include a direct methanol fuel cell including a polymer electrolyte membrane.

The fuel supply system can also include a second fuel transferring unit adapted to transfer the fuel stored in the mixing unit to the electric generating unit. The fuel supply system can also include a concentration sensing unit adapted to sense a concentration of the fuel transferred from the mixing unit to the electric generating unit. The fuel supply system can also include a temperature sensing unit adapted to sense a temperature of the fuel transferred from the mixing unit to the electric generating unit.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a direct methanol fuel cell system using a fuel supply system according to an embodiment of the present invention;

FIG. 2 is a graph showing a relationship between fuel consumption and current generation in an electric generating unit of the fuel cell system according to an embodiment of the present invention;

FIG. 3 is a schematic view of the electric generating unit usable in the direct methanol fuel cell system according to an embodiment of the present invention; and

FIG. 4 is a block diagram of a direct methanol fuel cell system using a fuel supply system according to another embodiment of the present invention.

### DETAILED DESCRIPTION OF THE INVENTION

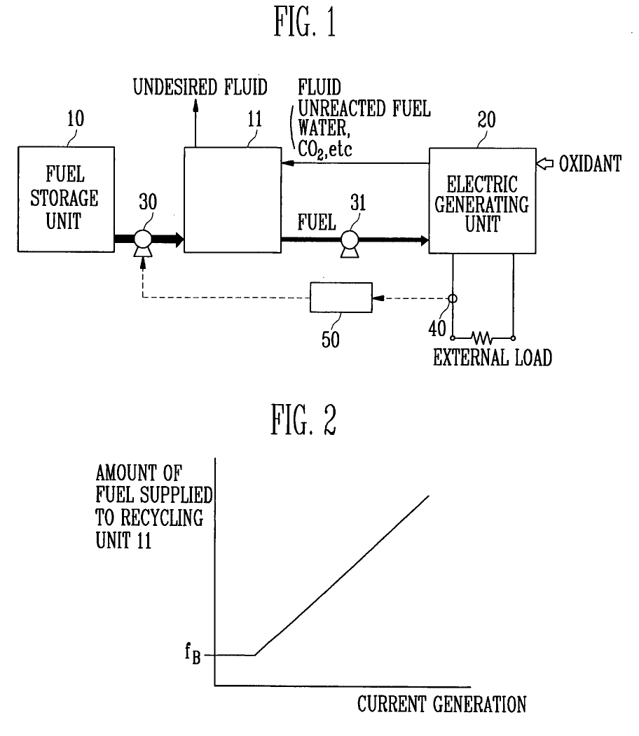

Turning to FIG. 1, FIG. 1 is a block diagram of a direct methanol fuel cell (DMFC) system using a fuel supply system according to an embodiment of the present invention. Referring to FIG. 1, the DMFC system according to an embodiment of the present invention includes a fuel storage unit 10, a recycling unit 11, an electric generating unit 20, a first fuel transferring unit 30, a second fuel transferring unit 31, a current detecting unit 40, and a control unit 50. Here, the fuel storage unit 10 stores hydrogen-containing fuel such as methanol or a methanol solution. The recycling unit 11 stores the fuel to be supplied to the electric generating unit 20, stores unreacted fuel and a predetermined amount of water in fluid produced from the electric generating unit 20, and discharges the other undesired fluids. The electric generating unit 20 generates electric energy based on an electrochemical reaction between the hydrogen-containing fuel and an oxidant, and supplies the generated electric energy to an external load. The first fuel transferring unit 30 transfers the fuel stored in the fuel storage unit 10 to the recycling unit 11 at a predetermined speed or predetermined volume flow rate. The second fuel transferring unit 31 transfers the fuel stored in the recycling unit 11 to the electric generating unit 20. The current detecting unit 40 detects current generated in the electric generating unit 20, and transmits information about the intensity of the detected current to the control unit 50. The control unit 50 controls the first fuel transferring unit 30 to adjust the amount of the fuel supplied from the fuel storage unit 10 to the recycling unit 11 on the basis of the information (a current value) received from the current detecting unit 40. In the DMFC system, the first fuel transferring unit 30, the current detecting unit 40 and the control unit 50 constitutes a fuel supply system for a fuel cell according to an embodiment of the present invention.

The fuel supply system employed in the DMFC system of this embodiment calculates fuel consumption changes in direct proportion within a linear function section on the basis of the intensity of current detected by the current detecting unit 40, and controls the amount of fuel supplied from the fuel storage unit 10 to the recycling unit 11 in correspondence to the calculated fuel consumption, thereby accurately controlling each of the concentration of fuel supplied to the electric generating unit 20 and the concentration of fuel stored in the recycling unit 11 to have the optimum concentration.

In the fuel supply system according to an embodiment of the present invention, the optimum fuel concentration for the maximum efficiency depending on characteristics of the electric generating unit 20 or characteristics determined by crossover fuel supplied from an anode to a cathode and water osmosis can be accurately maintained by only the intensity of the current generated from the current generating unit 20. Here, the characteristics of the electric generating unit 20 includes a cell voltage of a membrane-electrode assembly, fuel concentration dependence, temperature dependence, and the thickness of an electrolyte membrane. Therefore, the electric generating unit 20 can be stably driven for a long time with optimum efficiency without using a separate device such as a methanol sensor or requiring additional installation thereof.

Below, the operation of the fuel cell system according to an embodiment of the present invention will be described in more detail. For example, methanol or the methanol solution (hereinafter, referred to as “MeOH”), which has high energy density per volume and is easily storable, will be described as the fuel, of which the volume flow rate is controlled by the fuel supply system of the DMFC system proper for low power output and long time use.

First, in one unit cell of the electric generating unit 20 provided in the DMFC system according to the present invention, a current (I), that is, the quantity of electric charge (Q_{cell}) per unit time (t), can be represented by the following equation 1.

$$I = \frac{{Q}_{cell}}{t} = \frac{{nFR}_{MeOH - cell}}{t} \qquad [ Equation 1 ]$$

where, n is a mol number of electrons generated per MeOH 1 mol, e.g., n=6; R_{MeOH-cell} is a mol number of MeOH needed for the reaction in the unit cell; F is a Faraday's constant that is the quantity of electron charges corresponding to electrons of Imol, i.e., F=e * N=1.602×10⁻¹⁹[C]×6.023×10²³mol⁻¹=96485[C]/mol. e− is the quantity of electric charge per electron, and N is Avogadro's number.

Meanwhile, the mol number of MeOH needed for the reaction of the unit cell can be represented by the volume flow rate of MeOH needed for the reaction of the unit cell and the concentration of MeOH introduced into the stack, which is as follows.

R_{MeOH-cell}=0.001v_{MeOH-reac}C_{feed} [Equation 2]

Where, R_{MeOH-cell} is the mol number of MeOH needed for the reaction of the unit cell [mol/min]; v_{MeOH-reac} is the volume flow rate of MeOH needed for the reaction of the unit cell [cc/min]; and C_{feed} is the concentration of MeOH introduced into the stack [mol/L].

By substituting the Equation 2 for the Equation 1, the following equation 3 is obtained.

$$\begin{matrix}Qcell [ C ] = {nFR}_{MeOH - cell} \\ = 0.001 {nFv}_{MeOH - reac} {C}_{feed} \\ = 0.001 * 6 * 96485 * {v}_{MeOH - reac} {C}_{feed} \\ = 578.91 {v}_{MeOh - reac} {C}_{feed}\end{matrix} \qquad [ Equation 3 ]$$

Further, the current (I) of the unit cell in the electric generating unit of the DMFC system can be represented as follows.

$$I = \frac{{P}_{stack}}{{V}_{stack}} = \frac{{P}_{stack}}{{N}_{stack} {V}_{cell}} \qquad [ Equation 4 ]$$

Where, P_{stack} is output power of the electric generating unit; V_{stack} is an output voltage of the electric generating unit, N_{stack} is the number of unit cells in the electric generating unit; and V_{cell} is an average voltage of the unit cells in the electric generating unit.

On the basis of the Equations 1, 2 and 4, the consumption speed of MeOH needed for the reaction of total unit cells in the electric generating unit can be calculated by the following Equation 5.

$$\begin{matrix}I = \frac{{P}_{stack}}{{N}_{stack} {V}_{cell}} \\ = \frac{{Q}_{cell}}{t} \\ = 578.91 {v}_{MeOH - reac} {C}_{feed}\end{matrix} \\ {v}_{MeOH - reac} = \frac{{P}_{stack} t}{578.91 {N}_{stack} {V}_{cell} {C}_{feed}} \\ \begin{matrix}{v}_{MeOH - stack - reac} [ {cm}^{3} \text{/} min ] = {N}_{stack} {v}_{MeOH - reac} \\ = \frac{{P}_{stack} t}{578.91 {V}_{cell} {C}_{feed}} \\ = 0.1036 \frac{{P}_{stack}}{{V}_{cell} {C}_{feed}}\end{matrix} \qquad [ Equation 5 ]$$

Where, v_{MeOH-stack-reac} is the consumption speed of MeOH needed for the reaction of the electric generating unit.

Then, the mol number of MeOH needed for the reaction of the electric generating unit can be derived from the consumption speed of MeOH obtained by the Equation 5, which is as follows.

R_{MeOH-stack-reac} [mol/min]=0.001 v_{MeOH-stack-reac}C_{feed} [Equation 6]

Referring to the Equations 5 and 6, in the fuel supply system according to the present invention, the amount of fuel to be supplied to the fuel cell system is in direct proportion to the current generated by the electric generating unit, so that monitoring the current magnitude is a very convenient indicator for driving the fuel cell system.

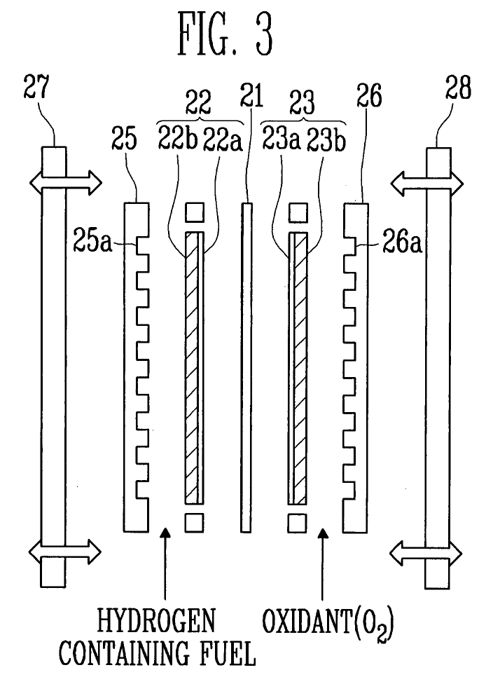

The graph of FIG. 2 shows the relationship between the amount of fuel supplied from the fuel storage unit 10 to the recycling unit 11 in correspondence to the fuel consumption speed and the current generated by the current generating unit 20. As shown in FIG. 2, the relationship between 5 the amount of supplied fuel and the generated current are expressed as a linear function having a predetermined gradient. Further, the amount of supplied fuel includes a minimum amount f_{B} whose value is based on the characteristics of the electric generating unit 20, i.e., the fuel cell stack. Thus, according to the present invention, the optimum fuel concentration preset in the fuel cell system can be accurately maintained based on the detected current of the electric generating unit without an additional device such as a methanol sensor or the like.

Meanwhile, before using results from the foregoing equations, the fuel supply system according to the present invention considers a characteristic variable of the electric generating unit 20, e.g., the amount of crossover fuel supplied from the anode to the cathode and the amount of water osmosis. In other words, total amount of fuel substantially needed for the electric generation unit 20 can be calculated by considering the amount of crossover fuel and the amount of water osmosis, which are determined by dependence on the fuel concentration dependence, the temperature dependence and the thickness dependence of the electrolyte membrane, or the like of the electric generating unit 20. Here, total amount of fuel includes the minimum amount of supplied fuel determined by the characteristic of the electric generating unit 20.

For reference, the electrochemical reaction in the electric generating unit 20 can be represented by the following reaction formula 1.

Anode: CH₃OH+H₂O→CO₂+6H⁺+6e⁻ [Reaction formula 1]

Cathode: 3/2O₂+6H⁺+6e⁻→3H₂O

Total: CH₃OH+3/2O₂→CO₂+2H₂O

Further, the reaction formula 1 can be also represented by the following reaction formula 2 in consideration of the amount of water transferred from the anode to the cathode of the electric generating unit 20 via the electrolyte membrane, i.e., the amount of water osmosis.

Anode: CH₃OH+19H₂O→CO₂+6H⁺(3H₂O)+6e⁻ [Reaction formula 2]

Cathode: 3/2O₂+6H⁺(3H₂O)+6e⁻→21H₂O

Total: CH₃OH+3/2O₂→CO₂+2H₂O

Referring to the reaction formulas 1 and 2, the amount of MeOH actually consumed in the electric generating unit 20 includes a crossover amount of about 20% (in case of Nafion™ based electrolyte membrane) in addition to the amount consumed in the reaction. Here, the crossover amount includes the amount of MeOH transferred from the anode to the cathode via the electrolyte membrane and the amount of water osmosis.

According to the present invention, when the value of C_{feed} is set as the optimum fuel concentration according to the characteristics of the electric generating unit 20, the mol number of MeOH is determined by the current generated from the electric generating unit 20, i.e., the number of unit cells * cell current (P_{stack}/V_{cell}), and thus the amount of fuel corresponding to the determined mol number of MeOH and the volume flow rate of MeOH aqueous solution corresponding to the preset crossover amount of MeOH aqueous solution (i.e., sum of the amount of crossover fuel and the amount of water osmosis) are supplied from the fuel storage unit 10 to the recycling unit 11. Therefore, the concentration of fuel stored in the recycling unit 11 and supplied from the recycling unit 11 to the electric generating unit 20 is accurately maintained. According to the present invention, the electric generating unit 20 continuously receives fuel with constant concentration, i.e., with the preset optimum concentration irrespective of load change or generated power, so that it can operate stably for a long time at high efficiency.

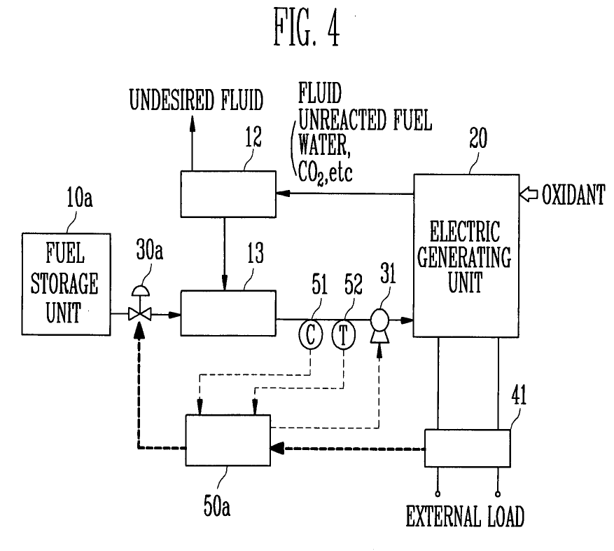

FIG. 3 is a schematic view of the electric generating unit usable in the direct methanol fuel cell system according to an embodiment of the present invention. Referring to FIG. 3, the electric generating unit according to an embodiment of the present invention includes a direct methanol fuel cell stack. In general, a plurality of unit cells are structurally stacked or electrically connected in series to get a desired output voltage. In this embodiment, a simple electric generating unit that has a single cell will be described by way of example.

The electric generating unit includes at least one unit cell. The unit cell includes a polymer electrolyte membrane 21, and an anode electrode 22 and a cathode electrode 23 adhered to opposite sides of the electrolyte membrane 21. The electrode membrane 21, the anode electrode 22 and the cathode electrode 23 of the unit cell are called a membrane-electrode assembly. Preferably, the anode electrode 22 and the cathode electrode 23 include metal catalyst layers 22a and 23a, and diffusion layers 22b and 23b, respectively, to enhance electrochemical reactivity, ion conductivity, electron conductivity, fuel transfer, by product transfer, interface stability, etc.

Further, the electric generating unit includes an anode plate 25 formed with a flow field 25a to supply fuel to the anode electrode 22, and a cathode plate 26 formed with a flow field 26a to supply an oxidant to the cathode electrode 23. Here, the anode plate 25 and the cathode plate 26 can be manufactured as one bipolar plate having opposite sides on which the flow fields 25a and 26a are exposed. When the unit cells are stacked by a pair of end plates 27 and 28, the bipolar plates are interposed between the unit cells in the electric generating unit.

The electric generating unit operates as follows. When the hydrogen-containing fuel is supplied to the anode electrode 22 and the oxidant is supplied to the cathode electrode 23, hydrogen ions produced in the anode metal catalyst layer 22a are transferred to the cathode electrode 23 through the polymer electrolyte membrane 21, and the hydrogen ions, oxygen and electrons are reacted in the cathode metal catalyst layer 23a, thereby producing water. In the meantime, the electrons produced in the anode metal catalyst layer 22a are transferred to the cathode electrode 23 through an external circuit, thereby transforming free energy based on the chemical reaction into electric energy. In the case that methanol is used as the hydrogen-containing fuel, methanol and oxygen are reacted as shown in the reaction formula 1, thereby producing water and carbon dioxide. Further, a crossover phenomenon arises in the electric generating unit, that is, the methanol aqueous solution is transferred from the anode electrode 22 to the cathode electrode 23 through the polymer electrolyte membrane 21. This crossover phenomenon is due to a current technical limit of the polymer electrolyte membrane 21.

The crossover phenomenon arises in all currently usable electric generating units. Therefore, according to the present invention, the amount of fuel supplied from the fuel storage unit 10 to the recycling unit 11 is accurately controlled such that the concentration of fuel stored in the recycling unit 11 and transferred to the electric generating unit 20 is maintained constantly in consideration of the amount of crossover fuel along with the amount of fuel consumed in the electric generating unit 20. Here, the concentration of fuel stored in the fuel storage unit 10 is higher than the concentration of fuel stored in the recycling unit 11.

Turning to FIG. 4, FIG. 4 is a block diagram of a direct methanol fuel cell system using a fuel supply system according to another embodiment of the present invention. Referring to FIG. 4, the direct methanol fuel cell system according to this embodiment of the present invention includes a fuel storage unit 10a to discharge stored fuel by its own elasticity or pressure, a fluid removing unit 12 to discharge undesired fluid such as carbon dioxide or the like among fluids coming out from the electric generating unit 20, a mixing unit 13 to store unreacted fuel and water among the fluids coming out from the electric generating unit 20, a first valve-type fuel transferring unit 30a to control the volume flow rate of high concentration fuel transferred from the fuel storage unit 10a to the mixing unit 13, a second fuel transferring unit 31 to transfer the fuel, of which concentration is maintained constantly according to the present invention, from the mixing unit 13 to the electric generating unit 20, a power convert unit 41 to convert and supply electric energy generated in the electric generating unit to an external load, and detect and transfer the current generated in the electric generating unit 20 to a control unit 50a, a concentration sensing unit 51 and a temperature sensing unit 52 to sense the concentration and the temperature of the fuel supplied from the mixing unit 13 to the electric generating unit 20 and provide the sensed information to the control unit 50a, and the control unit 50a to accurately control the concentration of the fuel to be stored in the mixing unit 13 by adjusting an opening of the first fuel transferring unit 30a on the basis of only the detected current value of the electric generating unit 20, maintain the concentration of the fuel supplied to the electric generating unit 20 constantly depending on the accurately controlled concentration of the fuel, and check whether the fuel cell system operates normally or not on the basis of the sensed information transmitted from the concentration sensing unit 51 and the temperature sensing unit 52.

In the DMFC system according to this embodiment of the present invention, the control unit controls the fuel to be supplied to the fuel cell system as much as the amount of fuel consumed in direct proportion to the current generated in the electric generating unit in consideration of the crossover amount, thereby accurately maintaining the optimum concentration of the fuel to be supplied to the electric generating unit. Further, the concentration of the fuel supplied to the electric generating unit is sensed by the concentration sensing unit, and it is determined whether the concentration of the fuel being currently supplied is normal or not on the basis of the sensed information. Then, the concentration of the fuel can be changed according to the determined results. Also, the temperature of the fuel supplied to the electric generating unit is sensed by the temperature sensing unit, and it is determined whether the temperature of the fuel being currently supplied is within a desired temperature range, e.g., more than 30° C. and less than 100° C. on the basis of the sensed information. Then, a warning message can be output according to the determined results.

As described above, in the direct methanol fuel cell system according to the present invention, the concentration of the fuel such as the methanol aqueous solution can be accurately controlled without an additional device such as a methanol sensor. Further, because the additional device is not needed, a simple and convenient system can be obtained. Also, the system is accurately controlled, so that optimum operation conditions are maintained while operating the system.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A fuel supply system, comprising:
an electric generating unit adapted to generate electric energy based upon an electrochemical reaction between a fuel and an oxidant;
a fuel storage unit adapted to store fuel and to supply fuel to the electric generating unit;
a recycling unit adapted to store unreacted fuel and water emitted from the electric generating unit;
a first fuel transferring unit adapted to transfer the fuel stored in the fuel storage unit to the recycling unit;
a second fuel transferring unit adapted to transfer the fuel within the recycling unit to the electric generating unit; and
a control unit adapted to calculate consumption speed of the fuel consumed in the electric generating unit based on a current generated by the electric generating unit, and the control unit being further adapted to control a volume flow rate of the fuel transferred from the fuel storage unit to the recycling unit in correspondence to the calculated consumption speed.

2. The fuel supply system of claim 1, wherein a relationship between the volume flow rate of the fuel transferred from the fuel storage unit to the recycling unit in correspondence to the consumption speed of the fuel and the intensity of the current is expressed as a linear function within at least a range.

3. The fuel supply system of claim 2, wherein the volume flow rate of the fuel transferred from the fuel storage unit to the recycling unit has a minimum amount determined by characteristics of the electric generating unit.

4. The fuel supply system of claim 1, further comprising a current detecting unit adapted to detect a magnitude of the current generated in the electric generating unit.

5. A fuel cell system, comprising:
an electric generating unit adapted to generate electric energy based upon an electrochemical reaction between a fuel and an oxidant;
a fuel storage unit adapted to store the fuel;
a fluid removing unit adapted to discharge undesired fluids among fluids emitted from the electric generating unit;
a mixing unit adapted to store unreacted fuel and water among the fluids emitted from the electric generating unit;
a first fuel transferring unit adapted to transfer the fuel stored in the fuel storage unit to the mixing unit; and
a control unit adapted to calculate a consumption speed of the fuel consumed in the electric generating unit based upon a current generated by the electric generating unit, and further adapted to control volume flow rate of the fuel transferred from the fuel storage unit to the mixing unit in correspondence to the calculated consumption speed.

6. The fuel cell system of claim 5, wherein a relationship between the volume flow rate of the fuel transferred from the fuel storage unit to the mixing unit in correspondence to the consumption speed of the fuel and a magnitude of the current is expressed as a linear function within at least a range, and the volume flow rate of the fuel transferred from the fuel storage unit to the mixing unit has a minimum amount determined by characteristics of the electric generating unit.

7. The fuel cell system of claim 5, further comprising a second fuel transferring unit adapted to transfer the fuel stored in the mixing unit to the electric generating unit.

8. The fuel cell system of claim 5, further comprising a concentration sensing unit adapted to sense a concentration of the fuel transferred from the mixing unit to the electric generating unit.

9. The fuel cell system of claim 5, further comprising a temperature sensing unit adapted to sense a temperature of the fuel transferred from the mixing unit to the electric generating unit.

10. The fuel cell system of claim 5, wherein the fuel transferring unit comprises at least one of a pump of which operating speed is controlled by the control unit and a valve of which a channel opening is adjusted by the control unit.

11. The fuel cell system of claim 5, wherein the electric generating unit comprises a direct methanol fuel cell including a polymer electrolyte membrane.
